(19) United States
(12) Patent Application Publication
(10) Pub. No.: US 2011/0318167 A1
(43) Pub. Date: Dec. 29, 2011

(54) CROSSFLOW WIND TURBINE

(76) Inventor: R. Scott Miller, Ballston Spa, NY (US)

(21) Appl. No.: 12/821,693

(22) Filed: Jun. 23, 2010

(51) Int. Cl. F03D 3/04; F03D 11/00; F03D 9/00

(52) U.S. Cl. 415/121.2; 415/203; 415/208.1; 290/55

(57) ABSTRACT

Disclosed herein is a wind turbine that includes a cylindrical impeller having a plurality of blades located about a radius of the cylindrical impeller, the blades having a span that is less than or equal to 20 percent of the radius. The wind turbine further includes an inlet duct that channels an airflow to the impeller and an outlet duct that channels the airflow away from the impeller substantially perpendicular to the inlet airflow in a plane that is perpendicular to a central axis of the impeller. Moreover, the inlet duct, the outlet duct and the impeller induce a recirculation zone in a center portion of the impeller that is located within the blades of the impeller.

### FIELD

The subject matter disclosed herein relates generally to wind turbines. More particularly, the subject matter relates to a crossflow wind turbine for installation on a roof or other structure.

### BACKGROUND

Small wind generation for both rural and suburban applications is dominated by small Horizontal Axis Wind Turbines (HAWT's) in the 1 to 20 kilowatt hour size range, usually mounted on towers of 10 to 20 meters in height. Vertical axis wind turbines may also be used, having a 360 degree yaw angle of acceptance. Vertical axis wind turbines may be particularly advantageous in urban settings having highly turbulent wind. Furthermore, tower mounting of these small wind generators is most common because it allows for operation higher in the atmospheric boundary layer. Tower mounting is also common because many typical residential and agricultural structures cannot directly accommodate the concentrated loads from direct mounting. Due to their designs, these existing small wind technologies generally have high capital costs compared to utility scale wind generation and conventional thermal resources. This is also in part because most wind technologies strive for cost effectiveness through efficiency increases with highly engineered aerodynamic designs and control systems, thereby increasing kilowatt hour per installed unit. Thus, the economic viability for small wind technologies, aside from niche applications, is largely dependent on subsidies. A substantial reduction in the installed cost of small wind devices is necessary before large scale utilization of this technology can be realized.

Thus, a relatively low cost crossflow wind turbine for installation on a roof or other structure would be well received in the art.

### BRIEF DESCRIPTION

According to one aspect of the invention, a wind turbine comprises: a cylindrical impeller having a plurality of blades located about a radius of the cylindrical impeller, the blades having a span that is less than or equal to 20 percent of the radius; an inlet duct that channels an airflow to the impeller; and an outlet duct that channels the airflow away from the impeller substantially perpendicular to the inlet airflow in a plane that is perpendicular to a central axis of the impeller; and wherein the inlet duct, the outlet duct and the impeller induce a recirculation zone in a center portion of the impeller that is located within the blades of the impeller.

According to another aspect of the invention, a wind turbine comprises: an impeller having a plurality of blades located about a radius, wherein the blades are thin, curved and narrowly spaced such that turbulent flow is reduced across the blades, wherein the blades have a thin span such that they do not approach a central axis of the impeller; an outer housing configured to be integrated on an edge of a building or structure such that a central axis of the impeller is parallel with the edge of the building or structure; an inlet duct that channels an inlet airflow to the impeller; an outlet duct that channels an outlet airflow away from the impeller an angle between 45 degrees and 135 degrees to the inlet airflow in a plane that is perpendicular to the central axis of the impeller; and a generator in operable communication with the impeller configured to convert the mechanical rotational energy of the impeller to electrical energy.

According to yet another aspect of the invention, a crossflow wind turbine comprises: a cylindrical impeller having a plurality of blades located about a radius of the impeller, the blades having a span that is less than or equal to 20 percent of the radius, wherein the blades are spaced at a distance that is less than 1.5 times the span of the blades; an inlet duct that channels an inlet airflow in a first direction to the impeller; an outlet duct that channels an outlet airflow in a second direction away from the impeller, wherein the second direction is substantially perpendicular to the inlet airflow in a plane that is perpendicular to a central axis of the impeller; and a foul prevention means configured to prevent fouling of the impeller.

### BRIEF DESCRIPTION

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

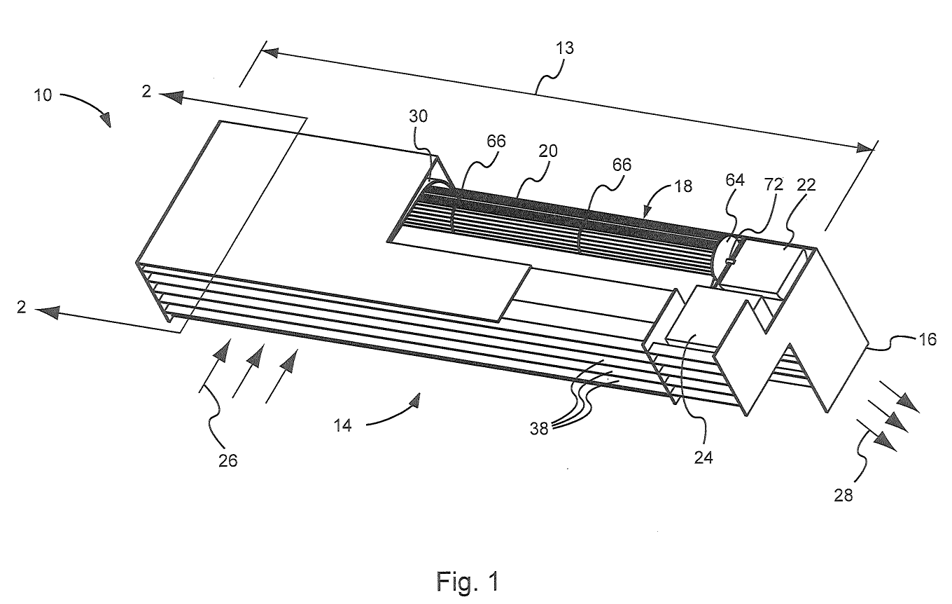

FIG. 1 depicts a perspective cutaway view of a crossflow wind turbine in accordance with one embodiment;

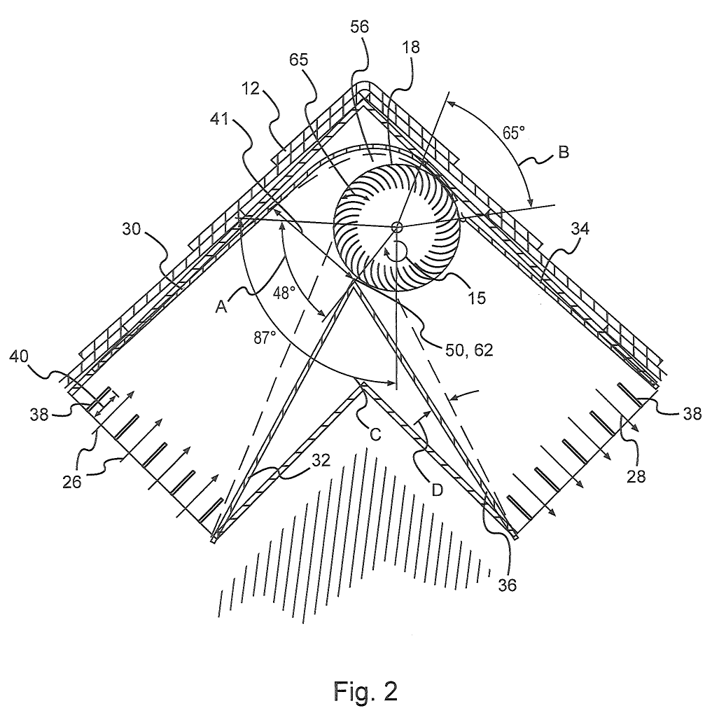

FIG. 2 depicts a cross sectional view of the crossflow wind turbine of FIG. 1, taken at arrows 2-2 in accordance with one embodiment;

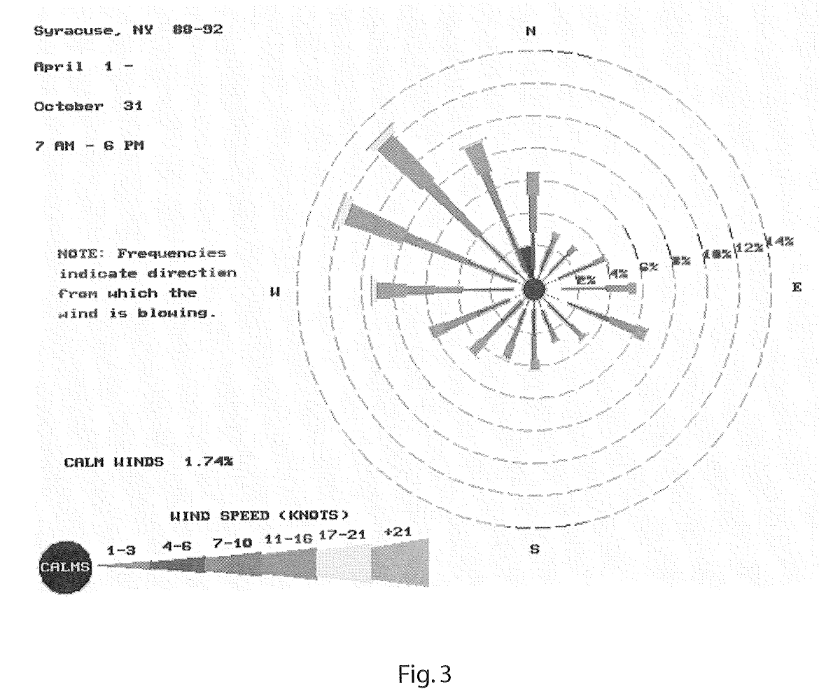

FIG. 3 depicts a wind rose for Syracuse, N.Y.;

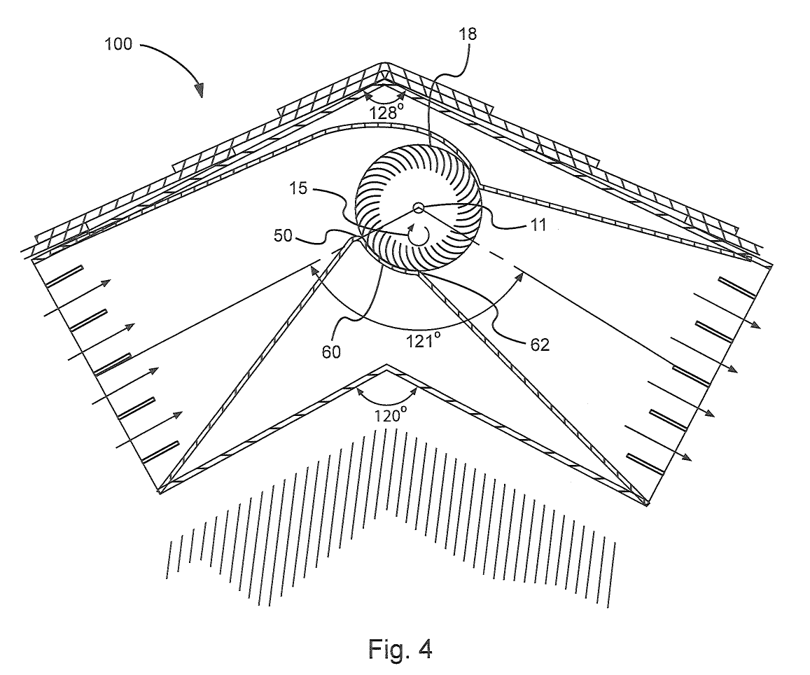

FIG. 4 depicts a cross sectional view of a crossflow wind turbine in accordance with one embodiment;

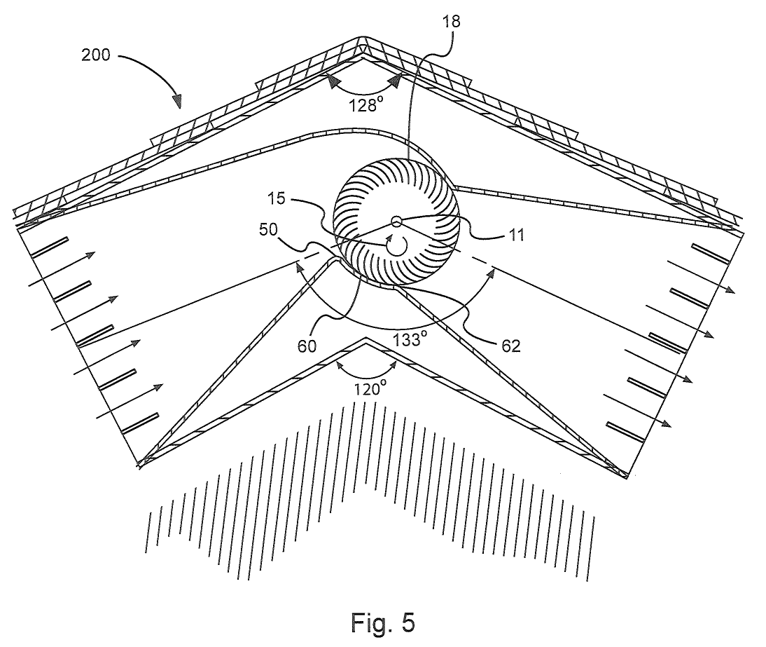

FIG. 5 depicts a cross sectional view of a crossflow wind turbine in accordance with one embodiment;

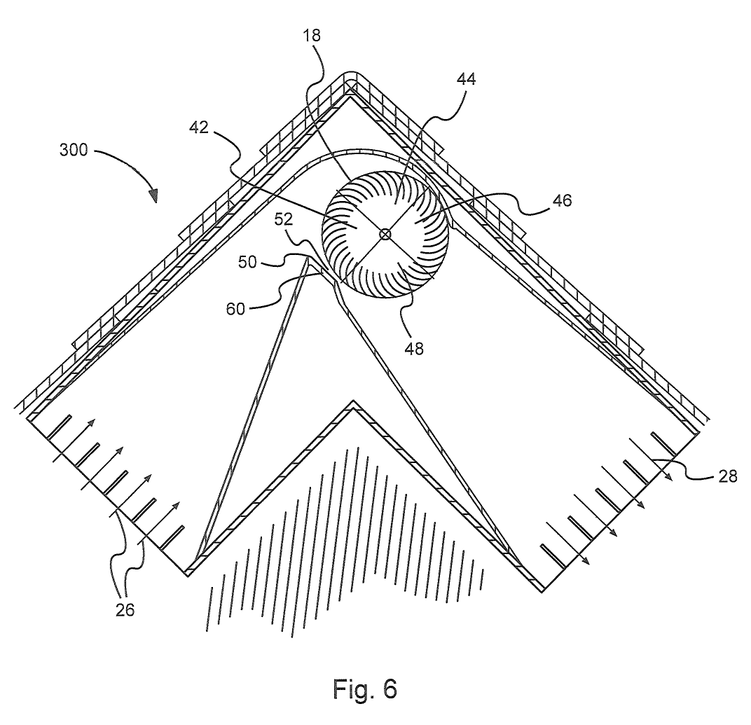

FIG. 6 depicts a cross sectional view of a crossflow wind turbine in accordance with one embodiment;

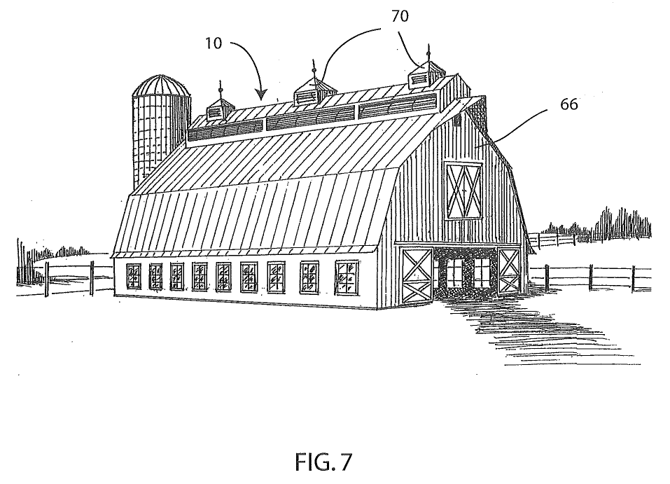

FIG. 7 depicts a perspective view of the crossflow wind turbine of FIG. 1 installed on a roof of an agricultural building in accordance with one embodiment; and

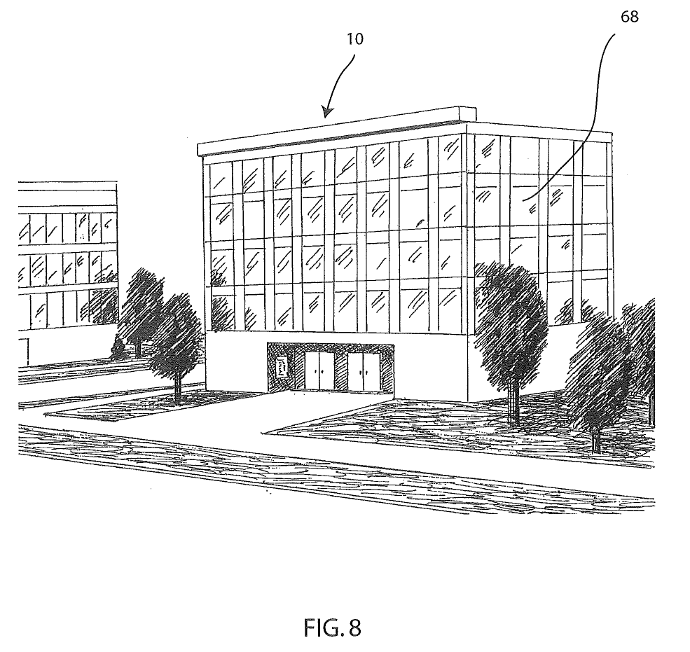

FIG. 8 depicts a perspective view of the crossflow wind turbine of FIG. 1 installed on top edge of a commercial building in accordance with one embodiment.

### DETAILED DESCRIPTION

A detailed description of the hereinafter described embodiments of the disclosed apparatus and method are presented herein by way of exemplification and not limitation with reference to the Figures.

Referring firstly to FIG. 1, a perspective cutaway view of a crossflow wind turbine 10 is shown having an outer housing 12 that is partially cut away to reveal several internal components. The crossflow wind turbine 10 has a length 13 and includes an inlet 14 for receiving an inlet airflow 26, and an outlet 16 for expelling airflow 28. In the particular embodiment depicted in FIG. 1, the direction of the inlet 14 is approximately ninety degrees from the direction of the outlet 16. Thus, the inlet airflow 26 enters the inlet 14 and the outlet airflow 28 exits the outlet 16 at a ninety degree directional change in a plane that is perpendicular to a central axis 11 of an impeller 18 or rotor. The impeller 18 or rotor includes a plurality of blades 20 that are located between the inlet 14 and the outlet 16. The airflow through the crossflow wind turbine 10 causes the impeller 18 to rotate. Furthermore, the structure of the inlet 14, the outlet 16 and the impeller 18 induces a recirculation zone 15 (shown in FIG. 2) in a center portion of the impeller 18 that is located within the blades 20 of the impeller 18. A variable speed generator 22 and an inverter 24 are shown in operable communication with the impeller 18, and are used to convert the rotational energy of the impeller 18 to usable electrical energy. The generator 22 may be a brushed permanent magnet type generator. The generator 22 may alternately be an electrically commutated permanent magnet type generator. Furthermore, the generator 22 may be reversible such that it may power the impeller 18 during a foul prevention process, as described hereinbelow.

The crossflow wind turbine 10 is configured for building integration. For example, the crossflow wind turbine 10 may be installed at an apex of a roof (shown in FIG. 7), or a corner of a building (shown in FIG. 8) such that the central axis 11 of the impeller 18 is parallel to the corner, apex, edge or ridge line. It should also be understood that the crossflow wind turbine 10 may be attachable to a vertical corner or edge of a building such that the crossflow wind turbine 10 is situated vertical. This embodiment may be particularly advantageous when implemented on tall buildings in cities. The crossflow wind turbine 10 may include various ducting and blade geometries, discussed hereinbelow, that allow the crossflow wind turbine 10 to operate efficiently at variable speeds. Embodiments of the crossflow wind turbine 10 are installable on a ridge line of any building or structure (shown in FIGS. 7-8). The crossflow wind turbine 10 may also include one or more means of preventing fouling of the impeller 18 with unwanted debris.

Referring now to FIG. 2, a cross sectional view of the crossflow wind turbine 10 of FIG. 1 is shown, taken at arrows 2-2. The crossflow wind turbine 10 is shown receiving the inlet airflow 26 and expelling the outlet airflow 28. The inlet 14 of the crossflow wind turbine 10 may be defined by an upper inlet ducting 30 and a lower inlet ducting 32. Likewise, the outlet 16 of may be defined by an upper outlet ducting 34 and a lower outlet ducting 36. In this embodiment, the ducting 30, 32, 34, 36 is configured such that inlet airflow 26 entering through the inlet 14 and exiting through the outlet 16 causes the impeller 18 to rotate in a clockwise direction.

The inlet ducting 30, 32 and the outlet ducting 34, 36 of the crossflow wind turbine 10 may be asymmetrical in order to optimize output of the impeller 18 when wind is coming from the inlet 14 rather than the outlet 16. This approach may optimize power output of the crossflow wind turbine 10 in an environment with wind that more often flows from one direction than another. For example, a wind rose for Syracuse, NY is shown in FIG. 3. This Figure illustrates that the large majority of the wind energy approaches the measured location from the North West direction. It is thus known in the art to determine which direction the wind will approach a given structure most often and place the crossflow wind turbine with the inlet 14 at least substantially facing that direction. It should be understood that the crossflow wind turbine 10 may be reversible, however, such that the crossflow wind turbine 10 may generate power in the case that wind enters the outlet 16 and exits from the inlet 14. The ducting 30, 32, 34, 36 is configured such that airflow entering the outlet 16 and exiting the inlet 14 would also cause the impeller 18 to rotate in a clockwise direction. It should be understood, however, that other embodiments are contemplated.

The crossflow wind turbine 10 may include one or more foul prevention means. For example, the crossflow wind turbine 10 is shown with a plurality of inlet and outlet louvers 38. The inlet and outlet louvers 38 may be configured to keep out unwanted debris from the crossflow wind turbine 10, and particularly from the impeller 18. The inlet and outlet louvers 38 may be spaced apart such that unwanted debris is prevented from entering the ducting 30, 32, 34, 36, while not substantially reducing the velocity of the inlet airflow 26. The inlet and outlet louvers 38 may prevent birds, bats, squirrels, or the like from entering the ducting 30, 32, 34, 36 of the cross flow wind turbine 10. The louvers 38 may run the entire length 13 of the crossflow wind turbine 10 and may have a width 40. The width 40 may be any distance that is desirable to perform their function of preventing foul from entering the impeller 18. For example, the louvers 38 may have a width between 1 inches and 5 inches. In other embodiments, the crossflow wind turbine 10 may not include the inlet and outlet louvers 38, but instead may include other foul prevention means such as a mesh screen (not shown). Still further, the foul prevention means may be that the crossflow wind turbine 10 may be configured to periodically rotate the impeller 18 in zero wind conditions to prevent animals from making nests or the like to block the impeller 18 once windy conditions resume. Moreover, the foul prevention means may simply be that the crossflow wind turbine 10 is configured to constantly rotate at a minimum rotational speed in calm conditions. A final foul prevention means may comprise temporarily operating the impeller 18 at a high tip speed in the reverse direction to blow out debris. For example, if the typical rotation direction is clockwise (as shown in the Figures), the final foul prevention means may rotate the impeller 18 in a counterclockwise fashion.

Hereinafter, it should be understood that the “cross sectional height of the ducting” refers to the distance between the upper ducting 30, 34 and the respective lower ducting 32, 36 along an axis that is perpendicular from the upper ducting 30, 34. For example, an axis 41 indicates the cross sectional height of the ducting at a point that is proximate the impeller 18. Furthermore, hereinafter the cross sectional position about the impeller 18 will be defined by the angular degree from the top most point of the impeller 18. Thus, the right-most point of the impeller 18 will be herein referred to as being located at the 90° cross sectional position of the impeller 18, while the left-most point of the impeller 18 will be referred to as being located at the 270° position. Furthermore, the cross section of the impeller 18 may be broken up into four quadrants 42, 44, 46, 48 (shown in FIG. 6) by an intersecting X drawn through the central axis 11 of the impeller 18: a left quadrant 42, a top quadrant 44, a right quadrant 46, and a bottom quadrant 48. The left quadrant 42 is defined between the 225° and 315° cross sectional positions about the impeller 18. The top quadrant 44 is defined between the 315° and 45° cross sectional positions about the impeller 18. The right quadrant 46 is defined between the 45° and 135° cross sectional positions about the impeller 18. Finally, the bottom quadrant 48 is defined between the 135° and 225° cross sectional positions about the impeller 18. While these quadrants are only shown in FIG. 6, the general concept is applicable to any embodiment depicted in any of the Figures herein.

The cross sectional height of the upper and lower inlet ducting 26, 28 may narrow as the airflow 30 approaches the impeller 18. The narrowing of this cross sectional height may be desirable to accelerate the airflow 30 approaching the impeller 18, and also direct the airflow 30 to a more desirable location of the impeller 18. For example, the lower inlet ducting 30 may approach the upper inlet ducting 32 while the upper inlet ducting remains substantially parallel with the original inlet airflow 26, as shown in FIG. 2. This configuration may cause the airflow 26 to approach substantially the left quadrant 42 and the top quadrant 44 of the impeller 18. Thus, the airflow 26 may be expelled substantially from the right quadrant 46 and the bottom quadrant 48 of the impeller 18. Alternately, both the upper and the lower inlet ducting 30, 32 may substantially narrow, as shown in FIG. 5. The cross sectional height of the ducting 30, 32 at the inlet 14 may be greater than or equal to the cross sectional height of the inlet ducting 30, 32 at the impeller 18, shown at axis 41. The ratio of the cross sectional height at the inlet 14 to the cross sectional height at the impeller 18 (shown at axis 41) may be between 1:1 and 1:5. In the embodiments shown in the Figures, this ratio is approximately 2:1.

The lower inlet ducting 28 may approach the impeller 18 and end at a first cross sectional position 50 that is proximate the impeller 18. The first cross sectional position 50 may be located extremely close to the impeller 18, as shown in FIG. 2. Alternately, there may be a space 52 between the first cross sectional position 50 and the impeller 18 (shown in FIG. 6). Although the first cross sectional position 50 is shown at a particular location relative to the impeller 18 in FIG. 2, a range of positions A is contemplated. The range of positions A may be approximately 38° about the impeller. The range of positions A may span between a 275° cross sectional position and a 227° cross sectional position. Thus, if the first cross sectional position 50 is at the 275° cross sectional position then the cross sectional height of the inlet ducting may be smaller than if the first cross sectional position 50 is at the 227° cross sectional position.

The upper inlet ducting 30 may approach the impeller 18 and end at a second cross sectional position 54 that is proximate the impeller 18. Although the second cross sectional position 54 is shown at a particular location relative to the impeller in FIG. 2, a range of positions B is also contemplated. The range of positions B may be approximately 65° about the impeller. The range of positions B may span between a 18° cross sectional position and a 83° cross sectional position. The upper inlet ducting 30 may be curved around the impeller 18 over the top quadrant 44, slowly approaching (in the clockwise direction) the second cross sectional position 54 at the impeller 18. Thus, a gap 56 between the upper inlet ducting 30 and the impeller 18 may narrow as the upper inlet ducting 30 approaches (in the clockwise direction) the second cross sectional position 54. The second cross sectional position may be located extremely close to impeller 18 such that as much of the inlet airflow 26 as possible enters the impeller 18. As shown in FIG. 2, the upper outlet ducting 34 may approach the impeller 18 at the same second cross sectional position 54.

While FIG. 2 shows that the lower inlet ducting 32 and the lower outlet ducting 36 come to a pointed apex 50, 62, in other embodiments the lower inlet ducting 32 and the lower outlet ducting 36 may block a portion of the impeller 18. For example, FIGS. 4-5 show a cross sectional view of a configuration of the crossflow wind turbine 10 where the impeller 18 is blocked by a blockage 60 between the lower ducting 32, 36. Referring back to FIG. 2, a range of blockage C is shown. Any or all of a portion of the impeller 18 may be blocked by the blockage 60 that is located within this range C. The range of blockage C may be span between a 275° cross sectional position and a 188° cross sectional position. Thus, a span of up to 87° of the cross section of the impeller 18 may be blocked by the blockage 60. This blockage 60 may prevent the impeller 18 from receiving counter productive wind that would act to prevent rotation of the impeller 18 in the desired direction. Furthermore, the blockage 60 may provide that the incoming wind hits the impeller 18 from a direction that would create the maximum amount of rotational force on the impeller 18.

The lower outlet ducting 36 may approach the impeller 18 and end at a third cross sectional position 62 that is proximate the impeller 18. The third cross sectional position 62 may be located extremely close to the impeller 18, as shown in FIG. 2. Although the third cross sectional position 62 is shown at a particular location relative to the impeller 18 in FIG. 2, a range of positions D is contemplated. The range of positions D may be approximately 45° about the impeller. The range of positions D may span between a 225° cross sectional position and a 180° cross sectional position.

As described hereinabove, the outlet ducting 34, 36 may have a different cross sectional profile than the inlet ducting 30, 32. The outlet ducting 34, 36 may conform to the above described ranges A, B, C. Similar to the inlet ducting 30, 32, the cross sectional height of the outlet ducting 34, 36 may narrow as the ducting approaches the impeller 18. The narrowing of the cross sectional height of the outlet ducting 34, 36 in this manner may accelerate flow entering the outlet 16 when the crossflow wind turbine 10 is operating in reverse due to opposite directional wind patterns. Further, the restriction in the cross sectional height of the outlet ducting 34, 36 at the impeller 18 may increase efficiency of the crossflow wind turbine 10 operating in the typical wind environment with the inlet airflow 26 entering the inlet 14 and the outlet airflow 28 exiting the outlet 16.

Referring still to FIG. 2, the blades 20 of the crossflow wind turbine 10 may have a span 65. It should be understood that the blades 20 may also be referred to as vanes. The blades 20 may be spaced apart at close intervals about the entire circumference of the impeller 18. The spacing between the blades 20 may be such that turbulence is reduced despite the lack of an airfoil profile of the blades 20. The blades may be spaced at their tip at less than 1.5 times their span 65. Due to this close spacing, the blades 20 may simply be thin pieces of bent sheet metal. A specific airfoil profile designed to increase laminar flow is unnecessary. Rather than sheet metal, it should be understood that the blades 20 may also be made from plastic, wood, a composite material or the like. By using closely spaced, thin, bent blades rather than airfoil blades construction cost of the crossflow wind turbine 10 may be reduced.

The blades 20 of the crossflow wind turbine 10 may span less than 20 percent of the radius of the impeller 18. The blades 20 may be inwardly curved such that the outer most end of the blade 20 extends in a direction that is tangential to the central axis 11 of the impeller 18. As the blade 20 extends along its span 65 to the inner most end, the blade 20 is curved to extend in a direction that intersects (or comes closer to intersecting) the central axis 11 of the impeller 18. In the embodiment depicted in the Figures, the blades 20 are curved so that the outer tips of the blades 20 in the left quadrant 42 are extending from the middle of the impeller 18 in a downward direction. Thus, the blades 20 of the right quadrant 46 are extending from the middle of the impeller 18 in an upward direction. Thus, the inlet airflow 26 that approaches the left and top quadrants 42, 44 causes the impeller to rotate in the clockwise direction.

The structure of the inlet ducting 30, 32, the outlet ducting 34, 36 and the impeller 18 (including the blades 20) may induce a recirculation zone 15 in a center portion of the impeller 18 that is located within the blades 20 of the impeller 18. The recirculation zone 15 is a mini circulation zone within the impeller 18 that rotates in the same direction as the impeller 18. For example, the recirculation zone 15 may be located in the bottom quadrant 46 of the impeller 18 when the airflow is in the typical direction (in the inlet 14 and out the outlet 16). In this case, the bottom of the impeller is moving in a clockwise manner (from right to left), and the top of the recirculation zone is moving from left to right. In essence, the recirculation zone 15 in this example is a mini clockwise rotational zone located in the bottom quadrant within the impeller 18. It should be understood that the recirculation zone 15 may move to the top quadrant 44 within the impeller 18 when the airflow is reversed.

The impeller 18 may be held together with structural disks 64 located at the ends of the impeller 18. Bearings 72 (shown in FIG. 1) may be connected to the structural disks 64 and may support the impeller 18 at both ends. Intermittent disks 66 may also be included at intervals along the length of the impeller 18 to provide structural support for the blades 20. The intermittent disks 66 may be made from a robust but light material in order to reduce the amount of inertia of the impeller 18. Like the blades 20, the disks 64, 66 may be made from a metallic, plastic, wood, composite, or the like. In a further embodiment, the interior disks 66 may have a hollow interior to minimize the inertia of the impeller 18.

The impeller 18 may be operable, for example, between 100 and 4000 rotations per minute. The blades 20 of the impeller 18 may have an operable tip speed or velocity of up to two times the air velocity at the minimum cross sectional height of the inlet, represented at axis 41. The crossflow wind turbine 10 may further include a system for controlling the rotational speed of the impeller 18. This system may be configured to measure the shaft speed and shaft power of the impeller 18. With these measurements, the system may dither the shaft speed of the impeller 18 to obtain maximum power output from the impeller 18. Furthermore, the speed control may be configured to keep the ratio of the tip speed of the blades 20 to the inlet velocity of the airflow constant under normal power generation operation. Moreover the speed control may move at least one of the inlet ducting 30, 32 and the outlet ducting 34, 36 to allow bypass of airflow around the impeller 18 to reduce the aero efficiency of the impeller 18. This may be useful in extremely high wind situations where the blade speed has the potential for exceeding tolerances.

Referring now to FIG. 4, a cross sectional view of a crossflow wind turbine 100 is shown in accordance with another embodiment. In this embodiment, the crossflow wind turbine 100 is configured for application on a roof or ridge line that is at a 120° angle, rather than the 90° angle shown in the embodiment of FIGS. 1-2. It should be understood that applications are contemplated anywhere between 45° and 135°. For larger ridgeline angle applications, such as the embodiment shown in FIG. 4, the inlet ducting 30, 32 may compensate by making a greater angle θ with the bottom of the outer housing, thereby creating a similar airflow at the impeller to an embodiment with a lesser ridgeline angle. FIG. 5 shows a cross sectional view of a crossflow wind turbine 200 is shown in accordance with another embodiment where the ridgeline angle is also 120°. In this embodiment, the impeller 18 has been relocated to a lower position within the outer housing 12. To accommodate this relocation, the inner ducting 30, 32, 34, 36 may be moved. It should be understood that many particular inner ducting embodiments and impeller 18 locations are contemplated in an effort to achieve maximum efficiency at various locations.

Shown in FIG. 6 is a cross sectional view of a crossflow wind turbine 300 in accordance with yet another embodiment where the space 52 is located between the first cross sectional position 50 and the impeller 18. In this embodiment, the blockage 60 is located partially spaced from the impeller 18. This spacing 52 may also be useful in the situation where the control system is configured to reduce the efficiency of the impeller 18 as described hereinabove. Thus, the control system may remove the blockage 60 to allow airflow to more easily bypass the impeller 18 and reduce the efficiency of the cross flow wind turbine 10.

Referring now to FIGS. 7 and 8, perspective views of one of the cross flow wind turbines 10 are shown attached to two different buildings. FIG. 7 shows the cross flow wind turbine 10 attached to the apex or ridge of an agricultural building 66. FIG. 8 shows the cross flow wind turbine 10 deployed between a side and a roof of a flat-roofed commercial building 68. As shown in FIG. 7, the outer housing 12 of the crossflow wind turbine 10 may accept matching roof material cover such as a paneling of the agricultural building 66. Furthermore, the outer housing 12 and the ducting 30, 32, 34, 36 structure of the crossflow wind turbine 10 may be robust enough to support one or more architectural roofing structures and coverings, such as an aesthetic apex 70. The outer housing 12 and ducting 30, 32, 34, 36 of the crossflow wind turbine 10 may be made of a robust metallic material such as steel, sheet metal. However, it should be understood that other materials are contemplated. For example, wood, plastic, or composite materials are contemplated.

More than one of the impellers 18 may be connectable lengthwise in series along the apex of a roof. Furthermore, lengthwise sections of the crossflow wind turbines 10 may be manufactured with only the ducting 30, 32, 34, 36 surrounding the impeller 18 and without the generator 22 and the inverter 24, as only a single generator 22 and inverter 24 are necessary for each combination of series impellers 18. To connect the impellers 18, the bearings 72 may be attachable in a prefabricated manner such that the impellers 18 that are connected rotate together. Thus, if a ridge line is fifty feet long, and each stackable unit has a 10 foot length, five units may be connected in series to accomplish the maximum energy generation from the ridge line.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A wind turbine comprising:
a cylindrical impeller having a plurality of blades located about a radius of the cylindrical impeller, the blades having a span that is less than or equal to 20 percent of the radius;
an inlet duct that channels an inlet airflow to the impeller; and
an outlet duct that channels an outlet airflow away from the impeller substantially perpendicular to the inlet airflow in a plane that is perpendicular to a central axis of the impeller; and
wherein the inlet duct, the outlet duct and the impeller induce a recirculation zone in a center portion of the impeller that is located within the blades of the impeller.

2. The wind turbine of claim 1, wherein the blades are spaced at a distance that is less than 1.5 times the span of the blades.

3. The wind turbine of claim 1, wherein the blades are supported by a disk at intermediate positions along the length.

4. The wind turbine of claim 1, wherein the rotor is supported at both ends by a bearing.

5. The wind turbine of claim 1, wherein a plurality of impellers are connectable to the wind turbine in series.

6. The wind turbine of claim 1, further comprising a variable speed generator in operable communication with the impeller.

7. The wind turbine of claim 6, wherein the generator is a brushed permanent magnet type generator.

8. The wind turbine of claim 6, wherein the generator is an electrically commutated permanent magnet type generator.

9. The wind turbine of claim 6, wherein the generator is reversible such that it is capable of powering rotation of the impeller.

10. The wind turbine of claim 1, wherein the wind turbine is mountable on an edge of a structure with the central axis of the impeller parallel to the edge.

11. The wind turbine of claim 1, wherein the impeller is operable between 100 and 4000 rotations per minute.

12. The wind turbine of claim 1, wherein the impeller blades have an operable velocity of up to two times the air velocity at an inlet of the inlet duct.

13. The wind turbine of claim 1, wherein the blades are made of bent sheets of a material selected from the group consisting of a metal, a plastic and a composite.

14. The wind turbine of claim 1, further comprising a speed control that is configured to measure the shaft speed and shaft power and dithering speed to obtain maximum power output from the impeller.

15. The wind turbine of claim 14, wherein the speed control is configured to keep the tip speed ratio of the blades to the inlet velocity of the airflow constant under normal power generation operation.

16. The wind turbine of claim 14, wherein the speed control moves at least one of the inlet ducting and the outlet ducting to allow the bypass of air and to reduce the aero efficiency of the impeller.

17. The wind turbine of claim 1, further comprising at least one of:
a plurality of inlet louvers configured to prevent foul from entering the impeller; and
a plurality of outlet louvers configured to prevent foul from entering the impeller.

18. The wind turbine of claim 1, wherein the inlet ducting includes an upper inlet ducting and a lower inlet ducting, and wherein the cross sectional height of the ducting is reduced as the inlet ducting approaches the impeller.

19. The wind turbine of claim 18, wherein the lower inlet ducting approaches the impeller at a first cross sectional position, and wherein the first cross sectional position is between a 275° cross sectional position and a 227° cross sectional position about the impeller.

20. The wind turbine of claim 18, wherein the upper inlet ducting approaches the impeller at a second cross sectional position, and wherein the second cross sectional position is between a 18° cross sectional position and a 83° cross sectional position about the impeller.

21. The wind turbine of claim 20, wherein the upper inlet ducting is curved about the top of the impeller.

22. The wind turbine of claim 1, wherein the inlet duct converges as it approaches the impeller.

23. A wind turbine comprising:
an impeller having a plurality of blades located about a radius, wherein the blades are thin, curved and narrowly spaced such that turbulent flow is reduced across the blades, wherein the blades have a thin span such that they do not approach a central axis of the impeller;
an outer housing configured to be integrated on an edge of a building or structure such that a central axis of the impeller is parallel with the edge of the building or structure;
an inlet duct that channels an inlet airflow to the impeller; and
an outlet duct that channels an outlet airflow away from the impeller an angle between 45 degrees and 135 degrees to the inlet airflow in a plane that is perpendicular to the central axis of the impeller.

24. A crossflow wind turbine comprising:
a cylindrical impeller having a plurality of blades located about a radius of the impeller, the blades having a span that is less than or equal to 20 percent of the radius, wherein the blades are spaced at a distance that is less than 1.5 times the span of the blades;
an inlet duct that channels an inlet airflow in a first direction to the impeller;
an outlet duct that channels an outlet airflow in a second direction away from the impeller, wherein the second direction is substantially perpendicular to the inlet airflow in a plane that is perpendicular to a central axis of the impeller; and
a foul prevention means configured to prevent fouling of the impeller.
